(19) United States
(12) Patent Application Publication
(10) Pub. No.: US 2025/0315728 A1
(43) Pub. Date: Oct. 9, 2025

(54) VARIABLE RANGE, VARIABLE PRECISION, COMPRESSED, USER DEFINED NUMERICAL DATA FORMATS FOR MACHINE LEARNING

(71) Applicant: Ocean Logic Pty Ltd, Dee Why NSW (AU)

(72) Inventor: Vincenzo Liguori, Dee Why NSW (AU)

(73) Assignee: Ocean Logic Pty Ltd, Dee Why NSW (AU)

(21) Appl. No.: 19/080,861

(22) Filed: Mar. 16, 2025

(30) Foreign Application Priority Data
Apr. 9, 2024 (AU) 2024900993

(51) Int. Cl. G06N 20/00

(52) U.S. Cl. CPC G06N 20/00

(57) ABSTRACT

One aspect of the invention includes an apparatus comprising a compressor accepting a model variable such as a weight or activation of an ML model such as an LLM, the compressor converting the model variable to a coding pair, the coding pair consisting of a code and additional data. The model variable may be one of a variety of formats including an integer format, a posit format, part of a binary code group, part of a ternary code group, and one of a plurality of floating-pint formats. Another aspect is an interface apparatus for compressing internal floating-point numbers in memory to a data stream of compressed model variables. Another aspect is an interface apparatus for decompressing a data stream of compressed model variables to internal floating-point numbers in memory.

### RELATED APPLICATIONS

This application claims priority from Australian Provisional Application 2024900993, filed 2024 Apr. 9, said patent application being incorporated herein by reference, and referred to herein as AU2024900993.

### FIELD OF THE INVENTION

The present invention relates to machine learning (ML) models such as large language models (LLMs) and large convolutional neural networks (CNNs), and in particular to compressing ML model variables such as weights and activations therefor.

### BACKGROUND

Weight compression for a large ML models such as large language model (LLM) is a set of techniques designed to reduce the storage and memory requirements of the ML model's variables (weights and/or activations) while preserving performance. These methods are crucial for deploying large models efficiently on devices with limited resources, such as edge devices, or for reducing costs in large-scale cloud deployments. It is known that there is a need to reduce the bandwidth requirements. This is particularly true for edge devices that may include relatively power hungry and/or relatively slow DRAMs

Large language models have a huge number of weights and activations that can come in a variety of formats. There exist multiple numerical data formats for such LLMs, e.g., int8, bfloat16, fp8, and so forth, and these are often non-optimal for the application and not directly compatible with one another.

LLMs typically have a very large number of small-amplitude weights and much fewer large-amplitude ones that may be considered outliers.

There thus is a need to be able to support multiple numerical data formats and to use a minimal number of bits to represent them while, at the same, not being penalized by the outliers and forced to use a worst-case number of bits to represent them all.

Implementation of compression and decompression in hardware often requires complex circuits with large memory buffers, making it impractical for real-time applications. There thus is a need for efficient hardware implementations.

Current architectures struggle to efficiently share ML model variables such as weights across multiple processing units, leading to redundant memory access and increased bandwidth requirements. There thus also is a need for architectures that can share ML model variables across multiple processing units.

### SUMMARY OF THE INVENTION

As used herein, the terms “ML model variable” and “model variable” both refer to a weight or an activations of a ML model such as an LLM.

One aspect of the invention includes an apparatus comprising a compressor accepting a model variable of a ML model such as an LLM, the compressor converting the model variable to a coding pair, the coding pair consisting of a code and additional data. One aspect is that the model variable may be one of a variety of formats including an integer format, a posit format, part of a binary code group, part of a ternary code group, and one of a plurality of floating-pint formats. Another aspect is a method of converting a model variable to a coding pair, the coding pair consisting of a code and additional data. One aspect is that the model variable may be one of a variety of formats including an integer format, a posit format, part of a binary code group, part of a ternary code group, and one of a plurality of floating-pint formats,

In one version, the model variable is in a floating-point format having a sign, an exponent, and a mantissa. The compressor includes an entropy coder that compresses the exponent to the code. The additional data includes the sign and the mantissa. The apparatus is then able to convert any one of a plurality of floating-point formats to a corresponding coding pair.

In another aspect, the model variable is in posit format having a sign, an exponent, a regime part, and a mantissa. The entropy coder forms the code from the regime part and the exponent, and the additional data is formed from the sign bit and the mantissa.

In another aspect, the model variable is integer or is quantized to integer format and the compressor:
creates a special code for an integer of value 0; and
for a non-zero integer,
   adds 1 to the position of the most significant bit of the absolute value of the non-zero integer to form the code of the coding pair; and
   forms the additional data from the sign bit of the non-zero integer and the remaining bits after the most significant bit of the absolute value of the non-zero integer.

In another aspect, each coding pair is for a model variable in integer format or quantized to integer format.

In yet another aspect, the model variables are one of a group of binary model variables or a group of ternary model variables, and the coding pair is for the group of model variables. In the case of a group of binary model variables, the code of the coding pair is formed by directly encoding the bit-pattern of the group, and there is no additional data, while in the case of ternary model variables, the code of the coding pair is formed by coding the zero and non-zero model variables as a binary pattern, and the additional data contains just the sign of the non-zero model variables.

Yet another aspect is an interface apparatus for compressing floating-point numbers internal in a device to a data stream of compressed model variables. The apparatus includes a look-up table to map the exponent of an internal floating-point number to a code of a coding pair, and further includes logic to convert a number of bits of the mantissa of the internal floating-point number to a mantissa that together with the sign bit of the internal floating-point number forms the additional data of the coding pair, the number of bits depending on the code. The apparatus further includes a compressor to produce a compressed number of the data stream of compressed model variables in one compression time-interval.

Yet another aspect is an interface apparatus for decompressing a data stream of compressed model variables to floating-point numbers internal in a device, e.g., memory. The apparatus includes a decompressor configured to produce in a decoding time interval a coding pair for each compressed model variable of the data stream. The coding pair consisting of a code and additional data. The additional data has a pre-defined number of mantissa bits and a sign bit, the pre-defined number depending on the code. The apparatus further includes a lookup table to map the code of the coding pair to an exponent of an internal floating-point number; and a mantissa mapper configured to form from the additional data the mantissa of the internal floating-point number.

Yet another aspect is an interface apparatus for compressing fixed-point numbers internal in a device to form a stream of compressed model variables. The apparatus includes an absolute number operator followed by any needed rounding operator to form a mantissa and exponent, the mantissa and the sign of the integer forming additional data of a coding pair, a lookup table accepting the exponent to form the code of the coding pair, and a compressor accepting the coding pair to form a compressed model variable of the stream of compressed model variables every coding time interval.

Yet another aspect is an interface apparatus for decompressing a stream of compressed model variable into model variables in fixed-point format internal to a device. The apparatus includes a decompressor to produce a coding pair every decoding time interval, the coding pair being for a fixed-point format and consisting of a code and additional data whose size depends on the code. The apparatus further includes a converter to convert the additional data of the coding pair to a two's complement integer, a lookup table to map the code of the coding pair to an exponent; and a shifter to use the exponent to shift the two's complement integer into a fixed-point integer model variable in the device.

These and other aspects will become clear from the detailed description and the drawings.

### BRIEF DESCRIPTION OF THE DRAWINGS

FIG. 1 shows an embodiment of a compressor that converts a model variable to a coding pair.

FIG. 2A shows a floating-point number.

FIG. 2B shows an embodiment of a compressor for and method of forming a coding pair from a floating-point model variable.

FIG. 3A illustrates a number in posit form.

FIG. 3B illustrates a compressor for and a method of forming a coding pair from a posit number.

FIG. 4 illustrates a compressor for and a method of forming a coding pair from an integer.

FIGS. 5A and 5B respectively show a method of and a compressor for a group of 8 binary model variables, and for a group of 8 ternary model variables, respectively.

FIGS. 6A and 6B respectively show schematics of respectively inputting and outputting a stream of compressed model variables variable range, variable precision, compressed formats into or from a device.

FIGS. 7A and 7B respectively show embodiments of schematics of respectively inputting and outputting a stream of compressed model variables for the case of the internal representation being in fixed-point format.

FIG. 8 shows an embodiment of an interface apparatus for decoding a stream of compressed model variables and transferring into a floating-point format in a device that also supports the case where a value is mapped directly to a code.

FIG. 9 shows an example of an apparatus for coding (compressing) and decoding (decompressing) multiple streams in parallel.

FIG. 10 shows an embodiment of an apparatus that includes a plurality of processors each running the same LLM in lockstep.

### DETAILED DESCRIPTION OF THE INVENTION

### Forming Coding Pairs

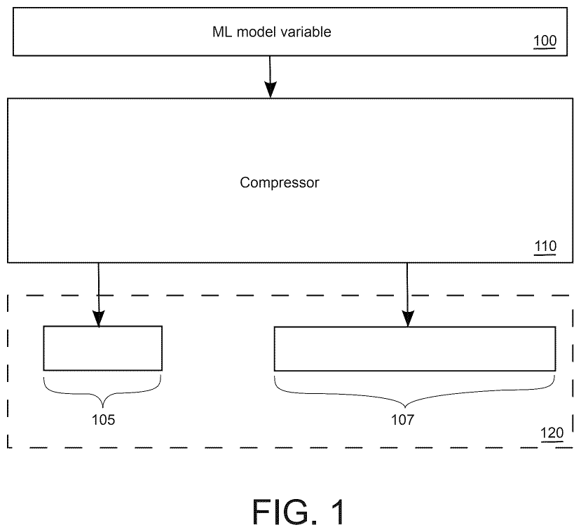

One aspect of the present invention is a method implemented in a processing system of forming coding pairs, and a compressor for forming coding pairs from ML model variables (weights or activations). FIG. 1 shows such an embodiment of a compressor 110 that converts a model variable 100 to a coding pair 120 consisting of an entropy-coded code 105 and additional data 107 that is preferably uncompressed. One aspect of the invention is that such coding pairs can be used to represent a plurality of compressed numerical data formats, including user defined, variable range, variable precision formats.

Consider as a first example the weights of the attention matrix Wq0 (Wq layer 0) for the (See Touvron, H., et al., “Llama 2: Open Foundation and Fine-Tuned Chat Models,” arXiv preprint arXiv: 2307.09288v2, 19 Jul. 2023). This is one of the four attention matrices Wq, Wk, Wv and Wo for the first of the 32 layers of Llama2 7B, each of these being approximately 16 million weights. Its histogram of frequencies shows that there is a large number of small-weights compared to a few large ones (in absolute value). Such a pattern is also present in the weights for all the fully connected layers (the matrices W1, W2 and W3), again in all 32 layers as well as the RMS final weight matrix. In other words, this pattern is present in essentially all the ˜7 billion parameters defining Llama2 7B. This pattern is also common in CNNs, and for other LLMs. Having mostly relatively small values suggests that the weighs can be losslessly compressed.

Consider now a floating-point representation of these weights. The weights are pretty symmetrical around zero such that there is a similar number of positive and negative values, such that the information carried by the sign is hardly compressible. Mantissa values are typically uniformly distributed such that they may not compress very well.

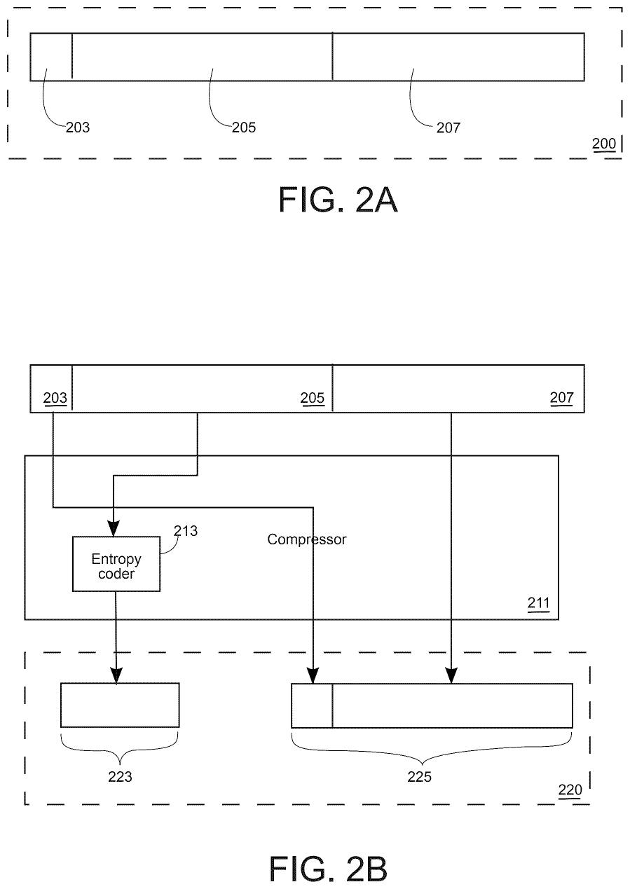

FIG. 2A shows a floating-point number 200 that consists of a sign bit 203, an exponent 205 and a mantissa 207. As an example, for Llama2 7B, the floating-point number is in bfloat16 format with the sign bit, the exponent of 8-bits, and the mantissa of 7-bits. FIG. 2B shows an embodiment of a compressor for and method of forming a coding pair 220 as the result of a first embodiment of representing a floating-point model variable. A compressor 211 includes an entropy coder 213 that codes the exponent 205 into the code 223 of the coding pair 220 and that forms the additional data 225 consisting of the sign bit 203 and the mantissa 207, uncompressed.

Note that for the Llama2 7B example, not all the possible exponents values are used by the weights; Llama2 7B weights have values in a limited range only. Counting how many unique exponent values exist for each of the Llama2 7B weight matrices separately, it turns out that for all the matrices but one, there are 31 unique exponent values, and 33 for the one other. This means that one could use a 5 to 6 bits code to encode all the exponents. Thus, for the coding pair for a bfloat16 Llama2 7B weight, one can losslessly encode any bfloat16value of the weights with 13 to 14 bits. This can save about 2.6 GB from the weights with relatively little effort. I call this the simple method.

For the Llama2 7B weights, I did the following: I downloaded the Llama2 7B weights from Meta, with their permission. As these weights were in fp32 format, I stripped the padding zeros to revert them to bfloat16. The values that were not used were stripped from the weights to generate a file of 13,214,154,752 bytes I call “original” having original size. Each of the weights in the file were converted into coding pairs as described above. All coding pairs were compressed (the entropy coder) using the simple method, with the rANS and tANS variants of Asymmetric Numeral Systems (ANS) as described in Jarek Duka, “Asymmetric numeral systems: entropy coding combining speed of Huffman coding with compression rate of arithmetic coding.” arXiv preprint arXiv: 1311.2540, 6 Jan. 2014. The rANS and tANS variants used a customized probability model for each matrix described further below. For comparison, I also compressed the same file with gzip -9 and bzip2 -9. The results are shown on Table 1, including a compression estimate for an ideal entropy coder.

TABLE 1
A comparison of coding of Llama2 7B weights.

| Method | % of original size | Avg weight (bits) | Avg code (bits) |
|---|---|---|---|
| Original | 100 | 16 | — |
| Simple | ~81.25 | 13 | 5 |
| Ideal | ~66.10 | ~10.58 | ~2.58 |
| rANS 16 bits | ~66.13 | ~10.58 | ~2.58 |
| tANS 8 bits | ~66.8 | ~10.69 | ~2.69 |
| Gzip −9 | ~79.29 | ~12.69 | — |
| Bzip2 −9 | ~69.38 | ~11.10 | — |

For the ideal entropy coder, it is known that a code with probability p can be encoded with—log₂(p) bits. One can estimate the probability of a code from its frequency counts and one can then use this to calculate the average number of bits needed to encode a code in the coding pair. When added to the additional data (fixed to 8 bits in the bfloat16 case), one obtains the average number of bits per coding pair which is the average number of bits used to code a weight in the ideal case. Note that all estimations for the ideal case were performed in double precision in C.

The same estimated probabilities were used to encode the coding pairs with tANS and rANS, with said probabilities reduced to 8 and 16 bits respectively. An ANS implementations in hardware is described in more detail in the priority Australian patent application AU2024900993.

Gzip and bzip2 are not based on coding pairs so their code size is absent from Table 1.

Note that the ANS based implementations outperform both gzip and bzip2 in all cases. This is particularly interesting because, as detailed further in AU2024900993, the tANS and rANS compressor/decompressors used here have a footprint of ˜200 lookup tables (LUTs) in AMD FPGAs (for tANS) and are capable of processing a coding pair every clock cycle at 800+MHz (again for tANS). In comparison, Gzip hardware implementations require one to two orders of magnitude more resources, especially for compressing. This is in addition to the relatively large memory buffer required.

While Table 1 is for the example of Llama2 7B weights, this can be extended to other floating-point weights for LLMs.

### Coding Pairs as Custom, Flexible Numerical Data Types

One aspect of the invention is a processor implemented method of forming coding pairs from a variety of users defined, variable range, variable precision, compressed numerical data formats of ML model variables.

Recall a coding pair consists of a code and an additional data. In a coding pair, the number of bits in the additional data does not need to be the same for each code: to each code value can be associated any number of bits of additional data, including none at all. In other words, the additional data can be variable in size, depending on the code and different for every code. This gives a lot of extra flexibility, as outlined in the examples below.

### Floating-Points

Embodiments of the invention can be used to form a coding pair from any floating-point model variable, the coding pair consisting of a code and additional data in the same manner as described above for fp8 model variables, for example fp16 and variations such as E5M2 (5 bits exponent+1 sign+2 mantissa) or E4M3. Coding pairs can represent them all.

In one set of variations for floating-point formats that have a relatively small exponent part, the method of forming a coding pair expands the exponent part prior to any coding. Having a large exponent may provide the best of both worlds: one gets rid of “range anxiety” while knowing that the compressor that forms the code will optimally take care of the outliers without a fixed, worst case size cost.

As two examples, for fp8 E5M2 and E4M3, respectively, the method instead uses fp11 E8M2 and fp12 E8M3, respectively, to generate the code and additional data.

For the Llama2 7B weights example, one knows exactly how these would compress if they were converted to fp8 E5M2 and E4M3 (by rounding the mantissa from 7 bits to 2 and 3 respectively). The exponents are exactly the same as for bfloat16 E8M7 and so they will compress exactly as in the example for calculating Table 1, and one can simply reuse the previous result, taking into account the reduced mantissa.

From Table 1 one knows that a code is compressed to an average of ˜2.6 bits. So, for fp11 E8M2, we have ˜2.6+1 bit sign+2 mantissa=˜5.6 bits/weight. For fp12 E8M3 is ˜6.6 bits/weight. Note that these both use less bits and have a much better range than fp8 E5M2 and E4M3, respectively.

### Posits

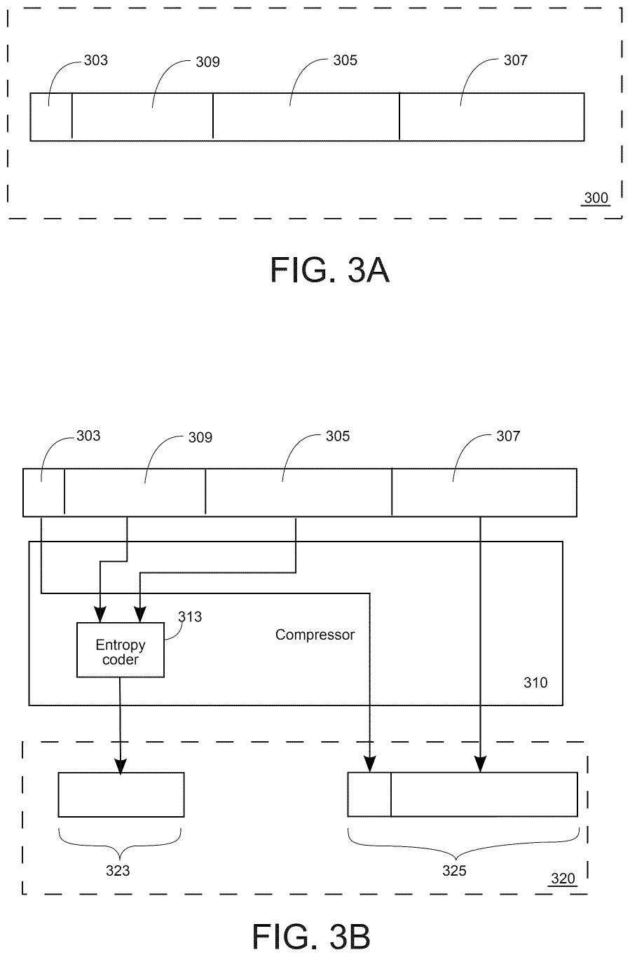

A posit is a numerical data type with a variable size exponent and mantissa. See J. L. Gustafson and I. T. Yonemoto, “Beating Floating point at its Own Game: Posit Arithmetic”, superfri, vol. 4, no. 2, pp. 71-86, April 2017. An exponent is formed from two fields: the regime bits and the exponent bits. The remaining bits, if any, form the (variable size) mantissa. In another example of the power of embodiments of the invention, a method embodiment forms a coding pair from a posits with a code assigned to occurring exponents and a variable number of bits constituting the additional data. FIG. 3A illustrates a model variable 300 in posit form with a sign bit 303, an exponent 305, a regime part 309 and a mantissa 307. FIG. 3B illustrates a compressor 310 for and a method of forming a coding pair 320 from the posit model variable 300. The code 323 is formed by an entropy coder 313 and the exponent 305 of the posit, while the sign bit 303 and the variable size mantissa 307 form the additional data 325 which typically is uncompressed. In this example, because the code is also formed from the regime, the number of bits of the additional data depends on the code.

### Integers

Quantization of model variables such as weights of CNNs and LLMs is common, and may result in (quantized) model variables that are Integers. In another example of the power of embodiments of the invention, a method embodiment of the invention forms a coding pair from an integer model variable as described below.

As a first example, if floating-point model variables are linearly quantized, the distribution of the model variables is similar to the distribution of the floating-point model variables with lots of small value and progressively fewer large ones. Such model variables are definitely compressible.

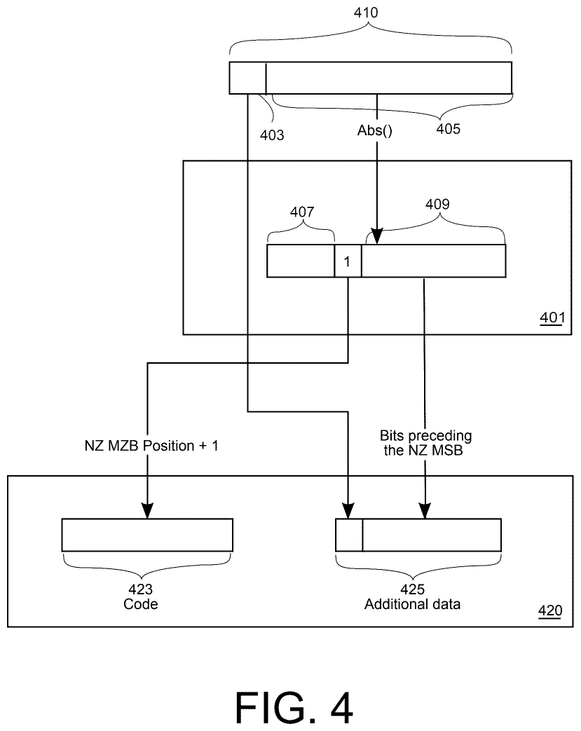

The method of and compressor 401 for forming a coding pair 420 from an integer model variable 410 is illustrated in FIG. 4. and includes:
creating a special code for an integer of value zero;
including the sign 403 of a non-zero (NZ) integer 410 in the additional data 425 of the coding pair 420;
adding 1 to the position of the most significant bit (the NZ MSB) 407 of the absolute value 405 of the non-zero integer 410 to form the code 423 of the coding pair 420; and
forming the additional data 425 from the sign bit 403 and the remaining bits 409 after the NZ MSB of the absolute value 405.

Note that NZ MSB is always 1, so it doesn't need to be encoded. Using such a method, for each code k, there are k bits of additional data.

Consider as a first example the number: −1: abs −1)=1, the position of NZ MSB is 0, code 0 is already used by the value zero so 0+1=1. Thus, the code is 1 and the additional data only contains the sign, so 1 bit only. As a second example, consider the number 13=1101b: the NZ MSB position is 3, so the code is 4, the additional data is the sign bit and 101b, so 4 bits.

Note that this representation is the same as the floating-point representation of the integers but with a variable size mantissa that depends on the exponent. As will be shown in the Hardware section below, this makes it particularly simple for an embodiment of interfacing logic.

In the method and compressor of FIG. 4 for forming coding pairs for integers, the additional data size keeps growing with the size of the integer. This precision might be unnecessary for many applications beyond a certain magnitude of the integer, and, at some point, one could limit the size to, for example, 8 bits. After all, bfloat16 numbers only have 7 bits mantissa. A kind of “saturation”. Thus, in one version of the method of representing an integer model variable as a coding pair, the size of the pair is limited to a predefined number of bits.

As an example, consider again the Llama2 7B matrices Wᵢⱼ. I uniformly quantized the coefficients N_{b} bits plus sign, each matrix separately, according to:

$$round ( \frac{{2}^{N} b - 1}{max ( \vert {W}_{i j} \vert )} {W}_{i j} ) .$$

I then encoded the resulting integer values according the method above with not

limiting the size, such that no “saturation” was used. I then estimated the size of the codes from −log₂(p) then added the number of bits of additional data. Table 2 shows the number of bits per weight averaged over all the weights after such linear quantization and compression.

TABLE 2

| N_{b} | 6 | 7 | 8 | 9 | 10 | 11 |
|---|---|---|---|---|---|---|
| Range | ±63 | ±127 | ±255 | ±511 | ±1023 | ±2047 |
| Avg bits/weight | ~3.391 | ~4.391 | ~5.391 | ~6.392 | ~7.392 | ~8.393 |

One final observation: this method of coding integers divides them into exponentially larger regions, that is 0, ±1, ±2−±3, ±4±7, ±8−15, and so forth. Within each region, the distribution is assumed to be uniform and thus the additional data that determines a particular integer is left uncompressed. Better compression may be possible.

One method includes subdividing the coding intervals further, in particular for intervals where the slope of probability distribution is furthest from the flat. Bringing this process to the limit, it is possible to assign a code for each quantized value. This might be quite practical, especially for lower bit quantization. For example, if the quantized numbers are 8 bits (7+sign), then 2⁷=128 codes plus the sign as part of the additional data is a perfectly acceptable. The hardware described in the priority document AU2024900993 and outlined below is perfectly capable of supporting 256 or more codes.

In any case, it is apparent that that entropy coding of quantized values may be advantageous.

### Magnitude Outliers

A common problem resulting from quantization of LLM weights and activations is the existence magnitude outliers: some weights in LLMs may be disproportionately large and uncommon compared to the rest. Using a fixed number of bits to represent the result of a linear quantization process may force choosing enough bits for the worst case, used by the uncommon, large weights.

In one embodiment of the invention, the post quantization values are encoded as described above and FIG. 4 for encoding integers. In this manner, fewer bits will be assigned to the more common, smaller values with the occasional, larger cost for the larger weights. The overall result will be a smaller representation compared with the number of bits actually used by the quantization, as shown in Table 2 for the example of the Llama2 7B matrices.

### Weight Saliency: the Other Outliers

In many of the above examples of creating coding pairs, the code is for the exponent, or in the case of an integer, for a magnitude. However, in some embodiments, the code of the coding pair includes extra information about the quantized model variable.

One application is for quantization methods that recognize that not all model variables are equally important. Some are more important than others and therefore should be less heavily quantized (if at all) if performance indicators such as perplexity are to be maintained. Normally, such more “important” model variables require to be encoded and marked as special cases in a bitstream. However, using coding pairs, there only is a need to use a code with more bits as additional data.

In some quantization methods, the additional data of the coding pair contains extra bits, and this identifies the model variable as an “important model variable”, and once such a model variable has been identified, it may be excluded from quantization or subjected to less quantization.

Note that “important” or “ordinary” model variables are not necessarily differentiated by their magnitude and they could be, potentially, very similar in value and even have the same exponents.

In one embodiment in which the code includes extra information, the extra information includes whether the model variable is “important” or is an ordinary model variable. Different such codes can have a different number of bits of additional data, allowing better precision for different codes.

In this manner, embodiments of the invention can assign in the coding pair different codes to each “important” and “ordinary” and assign different number of bits to the additional data. Thus, for example, using coding pairs, one can assign the same exponent two different codes: this way one can encode numbers in the same range in two different ways.

One possible advantage of thus forming coding pairs is that one does not have to encode “important” model variables separately in a bitstream. Such model variables can be automatically identified as such and dealt accordingly by the decompressor in the same way shown below in the Hardware section.

### Binary and Ternary Model Variables

Quantizing LLMs and CNNs to binary and ternary model variables also is known. One method embodiment includes converting these to coding pairs.

Besides the obvious assigning a code for each 0, +1, −1 (or to 0 and 1 for binary model variables), One method embodiment of encoding ternary and binary codes, applicable for example when there's a large number of zeros, encodes the ternary (or binary) code as pairs, each pair includes the run length of the zeros preceding the +1 or −1, and the sign of the +1or −1 non-zero model variable at the end. Method includes encoding the runs as unsigned integers as described above in the Integers section (see FIG. 4), with the sign of the model variable included in the additional data. For example, we can encode (000-1+100+1) from left to right as (3-1) (01) (21). The runs as unsigned integers as described above in the in the Integers section. Note that, since the zero runs are positive integers only, there's no need to add their sign to the additional data as was described in the Integers section of FIG. 4.

Of course, for binary model variables, zero runs can be encoded only as positive integers, since at the end of a run of zeros there's always a 1; there is no need to add anything.

Carrying out a dot product is one of the most important operations for CNNs and LLMs Encoding binary or ternary model variables as run lengths may have the additional advantage of being able to skip all the zeros that contribute nothing to a dot product.

Grouping model variables together could be advantageous from a compression point of view. For example, when forming groups of 8 model variables, it may be discovered that groups of more than, say, 5 non-zero model variables are unlikely (or some other pattern is unlikely). If there is such or similar unlikely-to-occur pattern, an entropy coder to form the code portion of a coding pair will find it and take advantage of it by assigning fewer bits to more likely patterns.

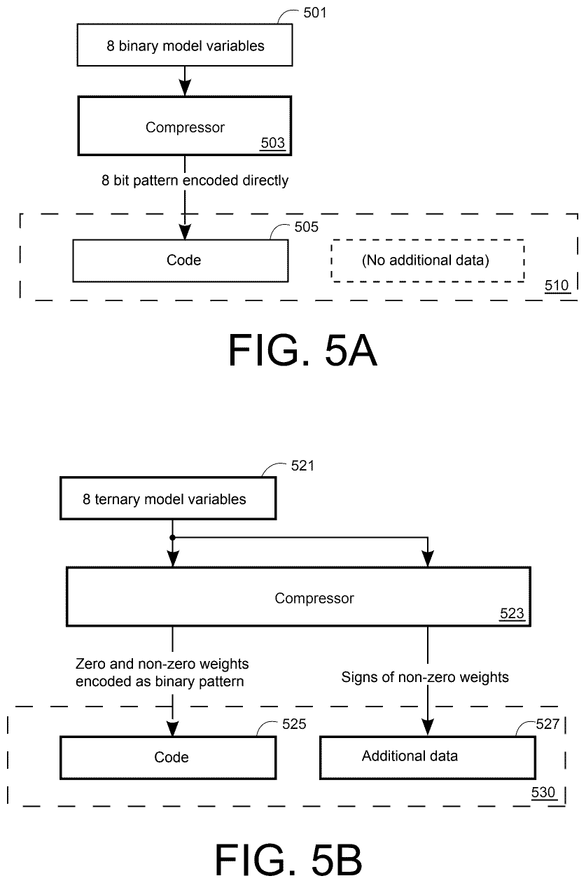

FIGS. 5A and 5B respectively show a possible way of doing for a this for a group of 8 binary model variables and 8 ternary model variables, respectively by creating a code with the presence of a model variable at a certain position. FIG. 5A shows a method of and a compressor 503 for a group 501 of 8 binary model variables to produce a coding pair 510. The code 505 of the coding pair 510 is formed by directly encoding the 8-bit pattern 503. There is no additional data in the coding pair 510. FIG. 5B shows a compressor 523 for forming a coding pair 530 for a group 521 of 8 ternary model variables. The code 525 of the coding pair 520 is formed by coding the zero and non-zero model variables as a binary pattern, while the additional data 527 of the coding pair 520 contains just the sign of the non-zero model variables. As a ternary model variable example, to encode (0-1+100-100), indicating with 1 the position of non-zero model variables, the code is 01100100b and the additional data for that particular code are the 3 bits: 101b (−1+1−1).

In a variation, for the case of lots of zeros, one method creates a hybrid system with run lengths of all zero groups with non-zero groups encoded as above. This may provide the best of both worlds: skipping useless zeros and have a compact representation.

Thus, method and compressor embodiments of the invention create coding pairs for several model variable formats, including floating-point, posits, integer, ternary-coded, and other user defined numerical data formats. In the coding pair, the code portion is entropy encoded and the additional data is preferably uncompressed.

### Hardware

Hardware for coding pairs includes an entropy coder to form the code, with the

additional data coming along for the ride, untouched. There is no restriction as to what entropy coder is used, one embodiment uses ANS. Alternate embodiments may use other forms of entropy coding, for example arithmetic coding or Huffman coding.

ANS Comes in two flavors: tANS based on a state machine implemented as a table and rANS, similar to range coding but simpler. Both flavors support probabilities that are not exact powers of two and it is possible to compress and decompress a coding pair in a single clock cycle in every case. Main difference from arithmetic coding or Huffman coding coders is that it works like a LIFO: if one compresses A, B, C, D, when decompressing, one gets D, C, B, A back. For model variable compression during inference, this is irrelevant: if one wants the model variables in a given order during decompression, just compress them back to front as this is normally done statically, off line. For activations this is a bit more involved but the amounts of data tend to be a lot smaller and so easier to encode in a different order using buffers.

I implemented both a tANS and a rANS compressor/decompressor cores capable of processing coding pairs with up to 64 codes and up to 8 bits additional data. The tANS cores support probabilities represented as 8 bits fixed-point numbers. The rANS core supports 16 bits probabilities.

Characteristics of the cores I implemented include:
Guaranteed compression/decompression of a coding pair every clock cycle;
Shallow logic resulting in high clock frequency (6-800 MHZ in FPGA, possibly 1.5-2 GHz in ASIC);
Small design size (few hundred LUTs in FPGA);
Possible to configure. number of codes and codes' probabilities. Each code can have a different additional data size associated with it;
Compressor outputs fixed size data words (16 bits for tANS, 32 bits for rANS), as internal bit buffers are filled; and
Decompressor requests fixed size data words (16 bits for tANS, 32 bits for rANS), as internal bit buffers are depleted.

Note that, by configuring the cores with the number of codes, their associated probabilities and additional data size in bits, it is possible to support all the coding pairs described above.

The cores are configured with normalized probabilities for the codes as defined by Pᵢ=nᵢ/2^{N} with nᵢ∈N, 0<nᵢ<2 and.

$${\sum }_{i = 0}^{{N}_{c} - 1} {n}_{i} = {2}^{N} ,$$

where N is the number of bits defining the probabilities, and N_{c} is the number of codes. Note that the above equation states that no code can have zero probability and that all probabilities, should add up to 1.

### Interfacing to a CNN/LLM Processor

One aspect of the invention is an almost glueless interface with which it is possible to input and output to and from a device, e.g., the memory of a computational engine all the compressed numerical data types described above (with the exception of when binary and ternary model variables are dealt as run lengths or groups). Two cases are described: a floating-point processor and a fixed-point one. In the following discussion, a compressor compresses model variables to coding pairs as described above, and a decompressor carries out the opposite operation: decompresses coding pairs to model variables.

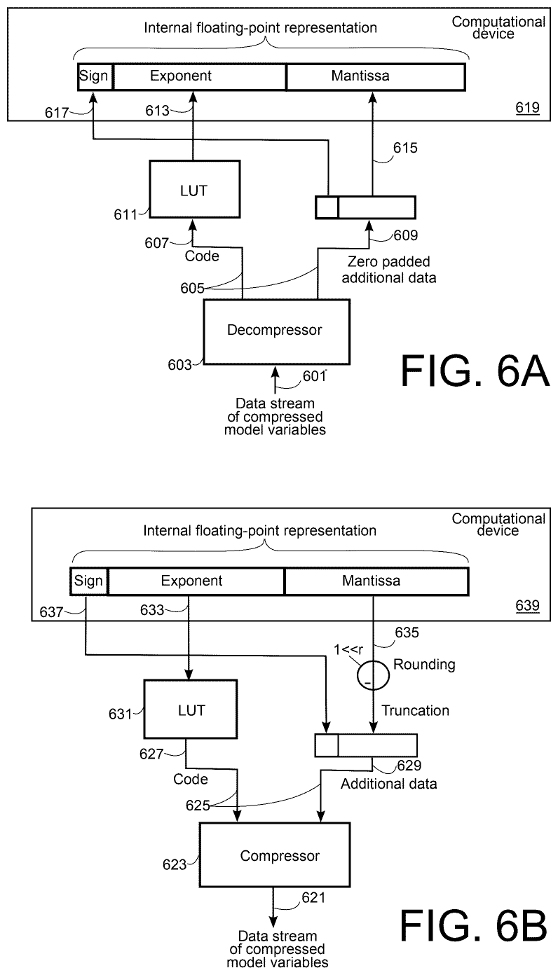

FIGS. 6A and 6B respectively show schematics of respectively inputting and outputting a stream of compressed model variables of the above-described variable range, variable precision, compressed formats into or from a computational device, e.g., memory of an LLM/CNN processor supporting internally floating-point numbers (of sufficient precision to avoid surprises). Different versions of the processor support bfloat16 or maybe even fp32 or some other non-standard floating-point format.

FIG. 6A shows an embodiment of an interface apparatus for decompressing a stream 601 of compressed model variables and transferring into a device, e.g., the memory of a processor. The apparatus includes a decompressor 603 configured with the number of codes, probabilities and additional data size information according to the type of coding pairs it is desired to support and that produces a coding pair 605 every decoding time interval, e.g., every clock cycle for the ANS decoder designs I created. The coding pair consists of a code 607 and additional data 609. The additional data has a pre-defined number of mantissa bits and a sign bit, the pre-defined number depending on the code. The apparatus includes a relatively small LUT 611 to map the code to an exponent 613. The decompressor 603 is configured to pad with zeros the additional data 609 to the size of the interface if the number of bits is too small. Some embodiments include saturation or underflow logic if the exponent of the decompressed numbers does not match the internal representation. The additional data includes the mantissa 615 and sign bit 617 of the floating-point representation that is input to the computational device 619, e.g., memory of a processor or computational engine.

FIG. 6B shows an embodiment of an interface apparatus for compressing internal floating-point numbers in a computational device 639, e.g., in memory to form a stream of compressed model variables and includes a look-up table 631 that is first initialized to map the exponent 633 of an internal floating-point number to a code 627 and some rounding logic that rounds the presumably more precise mantissa of the internal representation to the mantissa part that together with the sign bit 637 makes up the additional data 629 associated with the code 627 to form a coding pair 625. Thus, there is logic to convert a number of bits of the mantissa of the internal representation to the mantissa part of the additional data, the number of bits depending on the code. A compressor 623 is pre-configured, and from this configuration, it knows how many additional bits a specific coding pair should contain, and thus the apparatus includes automatically truncating the extra bits post rounding. While FIG. 6B shows the rounding being carried out explicitly, because the compressor 623 knows how many bits are required, the rounding is preferably carried out inside the compressor 623 to produce the data stream 621 of compressed model variables.

Once the compressor 623 is started, a floating-point number can be processed every coding interval, which using the ANS coder I created, is every clock cycle.

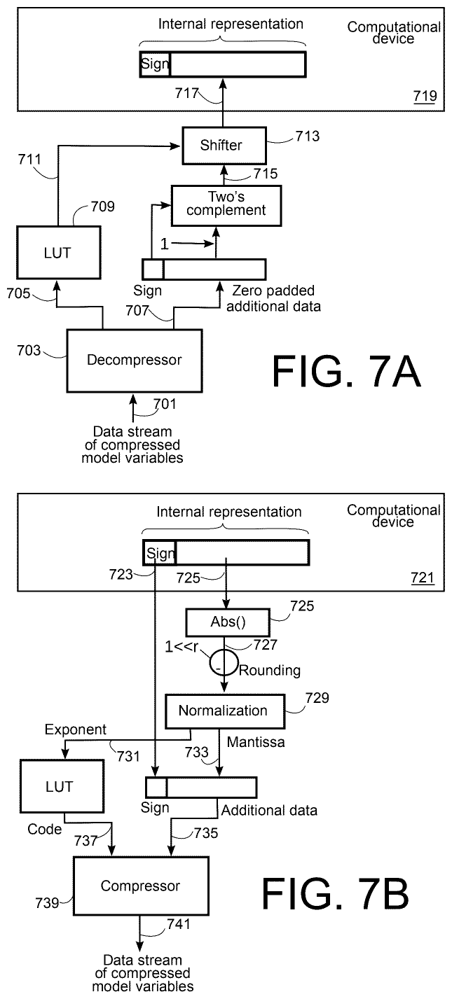

FIGS. 7A and 7B show the apparatuses for the case of the internal representation being in fixed-point format. FIG. 7A shows an embodiment of an interface apparatus for decompressing a stream 701 of compressed model variables and transferring into as a fixed-point format into a computational device 717, e.g., memory of a processor. The apparatus includes a decompressor 703 configured with the number of codes, probabilities and additional data size information according to the type of coding pairs it is desired to support and that produces a coding pair 705 every decoding time interval, e.g., every clock cycle for the ANS decoder designs I created, the coding pair being for a fixed-point format. The coding pair consists of a code 705 and additional data 707, the size of the additional data depending on the code. The additional data 707 (the mantissa, typically zero-padded) is converted to a two's complement integer 715. The code 705 is mapped to an exponent 711 with a look-up table 709. This is used by a shifter 713 to shift the reconstructed integer 715 into the fixed-point integer 717 of the internal representation in the computational device 719.

FIG. 7B shows an embodiment of an interface apparatus for compressing an internal fixed-point number in a computational device 721, e.g., memory to form a stream of compressed model variables. The sign bit 723 is the sign bit of the additional data 735 of the coding pair to be compressed. An absolute number operation 725 forms the absolute value of 727 of the integer number. A process called normalization 729 that, at least principle, can be performed with a priority encoder and a shifter that includes any needed rounding, as discussed for the case of FIG. 5B, forms the mantissa 733 of the coding pair, and also an exponent 731 that is converted by a lookup table into the code 737 of the coding pair. So, once the compressor 739 is initialized, it can compress a number into the data stream 741 of compressed model variables every coding time interval, which for the compressor/decompressor I built using ANS, is once every clock cycle.

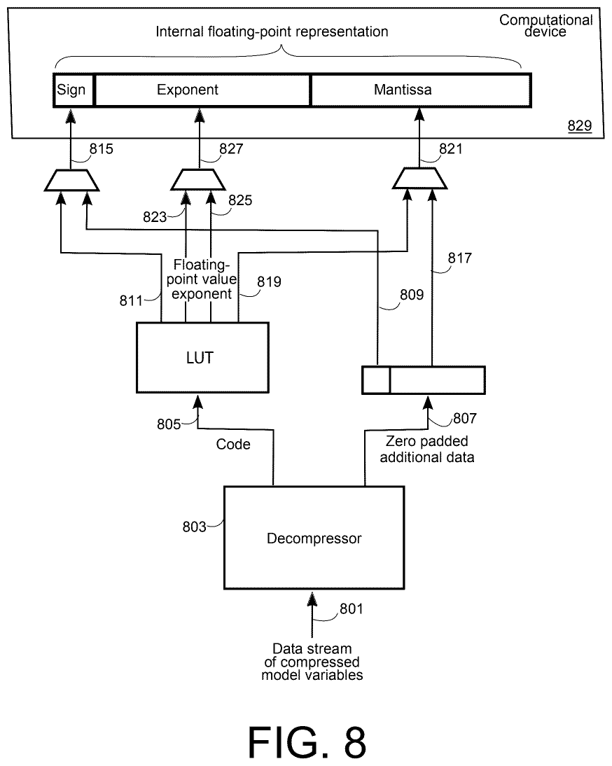

FIG. 8 shows an embodiment of an interface apparatus for decoding a stream of model variables 801 and transferring into a floating-point format in a computational device 829, e.g., memory of a processor that also supports the case where the stream of model variables includes both compressed model variables and some model variables in floating form format that is mapped directly to a code. This, for example may be useful for floating point numbers implemented with very few bits, e.g., non-standard fp4 (4 bits floating-point) which are then directly mapped to some larger floating-point values. The apparatus includes an alternate data path that converts the floating-point formats to the floating-point format of the device 829, and one or more multiplexors to select the alternate data path. In such a case, a bigger LUT is used that contains the value associated to each code. A multiplexer is used to bypass the normal path from the additional data and use the value directly.

In FIG. 8, the stream 801 of compressed model variables is decompressed by decompressor 803 to form code 805 and additional data 807. We call operating similarly to the system of FIG. 7A the normal path. For this path, the additional data includes a sign bit 809 and mantissa 817. The code goes to a LUT which determines, for example, if the code is for the normal path or is a floating-point format. The LUT includes logic to control a set of multiplexors via the LUT. This control logic is not shown in the drawing for simplicity. There is a multiplexor to select from two inputs for each of the sign 815, the exponent 827, and the mantissa 821 of the internal floating-point representation. In the case the LUT produces the complete floating-point number, the sign multiplexor selects a sign 811 from the LUT, else it selects the sign bit of the additional data. Similarly, the exponent multiplexor selects either the exponent 823 of the complete floating-point number or the exponent 825, and the mantissa multiplexor selects either the mantissa 819 of the complete floating-point number or the mantissa 817 of the additional data.

### Data Streaming

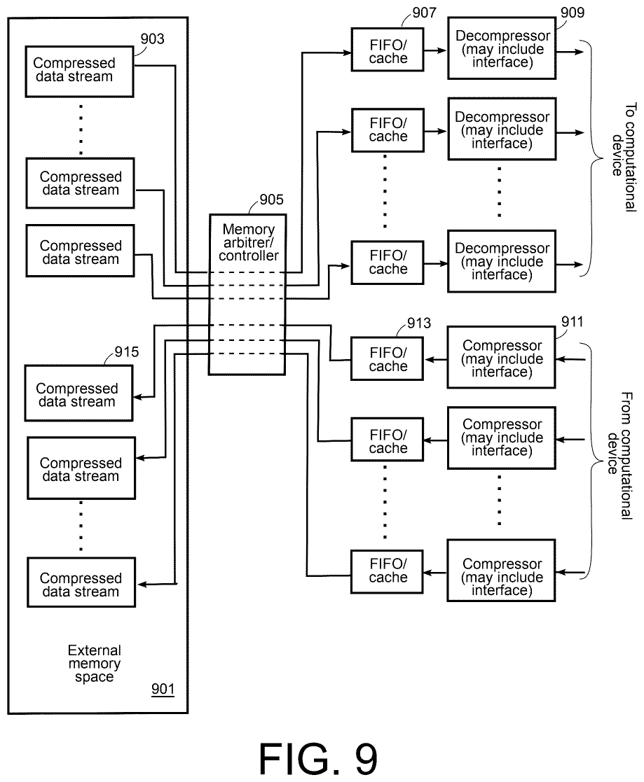

From the above, it is clear that compressors/decompressors can stream user defined numerical data types as compressed model variables. If the bandwidth provided by one unit is not sufficient, multiple ones can be instantiated in parallel, sharing a memory through FIFOs (operating as caches). FIG. 9 shows an example of an apparatus for coding (compressing) and decoding (decompressing) multiple streams in parallel. Each of the compressors and decompressors shown can include the interface circuits of FIGS. 6A, 6B, 7A, 7B, or 8. The compressed data is shown in memory 901. Consider for example a memory arbiter/controller 905 selecting a stream 903 of compressed data to pass onto a FIFO/cache 907 coupled to a decompressor 909 (typically with an interface circuit, see FIG. 6A or 8) to pass the decompressed number (floating-point) to a computational device, e.g., memory of a computational engine wherein the numbers reside. Similarly, to compress data from the computational device, a compressor with interface 911 (see FIGS. 5B) compresses a stream into a FIFO/cache 913. This stream is selected by the memory arbiter/controller 905 and passed as stream 915 onto the external memory space 901.

### An Inference Example: Model Variable Compression and Sharing

Since computation in LLMs is generally bandwidth bound, sharing the expensive model variable fetching infrastructure may be particularly advantageous. One embodiment of the invention provides for running multiple relatively slow processors simultaneously, resulting in the production of hundreds of tokens per second albeit on separate queries.

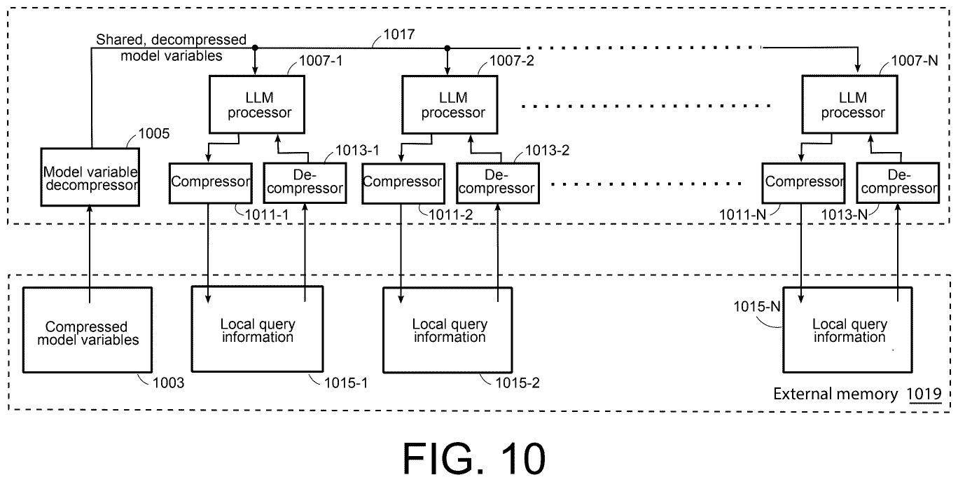

Consider the case of multiple instances of the same LLM simultaneously processing multiple, unrelated queries. FIG. 10 shows an example of a plurality of processors each running the same LLM in lockstep. In an alternate version, the processors run the same LLM close to being in lockstep, with buffers able to maintain synchronization. The LLMs require the same model variables at the same time. The model variable fetching and decompression infrastructure, shown as decompressor 1005 is shared amongst the processors.

Shown is a plurality of LLM processors 1007-1, 1007-2, . . . , 1007-N each receiving decompressed model variables 1017 from the decompressor 1005. The decompressor fetches compressed model variables 1003 from memory in memory infrastructure 1019 external to the LLM processors.

In one embodiment, the external memory infrastructure 1019 also includes local query information 1015-1, 1015-2, . . . 1015-N, respectively for each LLM processor 1007-1, 1007-2, . . . 1007-N, respectively, e.g., activations, KV caches, and so forth. The local query information is stored in compressed form, so there is a respective compressor 1011-1, 1011-1, 1011-2, . . . 1011-N and respective decompressor 1013-1, 1013-2, . . . 1013-N for each of the LLM processors. These compressor/decompressors in one embodiment are similar to those shown in FIG. 9, while the model variable decompressor 1005 in such an embodiment will be similar to the decompression part only.

Thus, sharing expensive model variable fetching infrastructure is possible.

### General

Unless specifically stated otherwise, as apparent from the following discussions, it is appreciated that throughout the specification discussions utilizing terms such as “processing,” “computing,” “calculating,” “determining,” “forming,” or the like, refer to the action and/or processes of a host device or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory.

The methodologies described herein are, in one embodiment, performable by one or more digital processors that accept machine-readable instructions, e.g., as firmware or as software, that when executed by one or more of the processors carry out at least one of the methods described herein. In such embodiments, any processor capable of executing a set of instructions (sequential or otherwise) that specify actions to be taken may be included. Thus, one example is a programmable DSP device. Another is the CPU of a microprocessor or other computer-device, or the processing part of a larger ASIC. Another is a GPU of a processing system. A digital processing system may include a memory subsystem including main RAM and/or a static RAM, and/or ROM. A bus subsystem may be included for communicating between the components. The digital processing system further may be a distributed digital processing system with processors coupled wirelessly or otherwise, e.g., by a network. The memory subsystem thus includes a machine-readable non-transitory medium that is coded with, i.e., has stored therein a set of instructions to cause performing, when executed by one or more digital processors, one of more of the methods described herein. Note that when the method includes several elements, e.g., several steps, no ordering of such elements is implied, unless specifically stated. The instructions may reside in the hard disk, or may also reside, completely or at least partially, within the RAM and/or other elements within the processor during execution thereof by the system. Thus, the memory and the processor also constitute the non-transitory machine-readable medium with the instructions. Another embodiment includes digital circuits that are controlled by a state machine or other similar sequencing//controlling circuits that can be typically implemented as ASIC or FPGAs.

Note that while some diagram(s) only show(s) a single processor and a single memory that stores the machine-readable instructions, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a non-transitory machine-readable medium coded with, i.e., having stored therein a set of instructions for execution on one or more digital processors, e.g., one or more digital processors that are part of the receiver forming a pen stroke capture system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a host device system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Note that the claims attached to this description form part of the description, so are incorporated by reference into the description, each claim forming a different set of one or more embodiments. In jurisdictions where incorporation by reference is not permitted, the applicant reserves the right to add such claims, forming part of the specification.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

1. An apparatus comprising:
a compressor accepting model variables of a ML model, the compressor converting the model variables to coding pairs, each coding pair consisting of a code and additional data, wherein the model variables are in one of a floating-point format, an integer format, a posit format, grouped as groups of binary model variables, and grouped as groups of ternary model variables.

2. The apparatus of claim 1, wherein each coding pair is for a model variable in a floating-point format having a sign, an exponent, and a mantissa, wherein the compressor includes an entropy coder that compresses the exponent to the code, and wherein the additional data includes the sign and the mantissa, said apparatus able to convert any one of a plurality of floating-point formats to a corresponding coding pair for the one floating point format.

3. The apparatus of claim 1, wherein each coding pair is for a model variable in posit format having a sign, an exponent, a regime part, and a mantissa, wherein the entropy coder forms the code from the regime part and the exponent, and the additional data is formed from the sign bit and the mantissa.

4. The apparatus of claim 1, wherein each coding pair is for a model variable in integer format or quantized to integer format, and wherein the compressor:
creates a special code for an integer of value 0; and
for a non-zero integer,
adds 1 to the position of the most significant bit of the absolute value of the non-zero integer to form the code of the coding pair; and
forms the additional data from the sign bit of the non-zero integer and the remaining bits after the most significant bit of the absolute value of the non-zero integer.

5. The apparatus of claim 1, wherein the model variables are in groups of binary model variables or groups of ternary model variables, and wherein the compressor produces a coding pair for each group.

6. The apparatus of claim 5, wherein the model variables are in groups of binary model variables, add wherein the code of the coding pair of a group is formed by directly encoding the bit-pattern of the group.

7. The apparatus of claim 5, wherein the model variables are in groups of ternary model variables, wherein the code of the coding pair is formed by coding the zero and non-zero model variables as a binary pattern, and wherein the additional data contains just the sign of the non-zero model variables.

8. An interface apparatus for compressing floating-point numbers internal in a device to a data stream of compressed model variables, the apparatus comprising:
a look-up table to map the exponent of an internal floating-point number to a code of a coding pair;
logic to convert a number of bits of the mantissa of the internal floating-point number to a mantissa that together with the sign bit of the internal floating-point number forms the additional data of the coding pair, the number of bits depending on the code; and
a compressor to produce a compressed number of the data stream of compressed model variables in one compression time-interval.

9. The interface apparatus of claim 8, wherein the logic includes rounding logic.

10. The interface apparatus of claim 8, wherein the compressor uses ANS and wherein one compression time-interval is one clock cycle.

11. An interface apparatus for decompressing a data stream of compressed model variables to floating-point numbers internal to a device, the internal floating-point numbers being of an internal floating-point format having a sign bit, an exponent and a mantissa, the apparatus comprising:
a decompressor configured to produce in a decoding time interval a coding pair for each compressed model variable of the data stream of compressed model variables, the coding pair consisting of a code and additional data, the additional data having a pre-defined number of mantissa bits and a sign bit, the pre-defined number depending on the code;
a lookup table to map the code of the coding pair to an exponent of the internal floating-point format; and
a mantissa mapper configured to form from the additional data of the coding pair the mantissa of the internal floating-point format, including padding with zeros the additional data in the case that the pre-defined number of mantissa bits in the additional data is less than the number of bits of the mantissa of the internal floating-point format,
wherein the sign bit of the internal floating-point number is the sign bit of the additional data, such that the interface apparatus is able to produce an internal floating-point number every decoding time interval.

12. The interface apparatus of claim 11, wherein the decompressor includes a decoder based on ANS, and wherein the decoding time interval is one clock cycle.

13. The interface apparatus of claim 11, wherein some of the model variables in the stream are in uncompressed floating-point form format, and wherein the apparatus includes an alternate data path that converts the uncompressed floating-point formats to the internal floating-point format, and one or more multiplexors to select the alternate data path.

14. An interface apparatus for compressing fixed-point numbers internal to a device to form a stream of compressed model variables, the apparatus comprising:
an absolute number operator followed by any needed rounding operator to form a mantissa and exponent from an integer in memory, the mantissa and the sign of the integer forming additional data of a coding pair;
a lookup table accepting the exponent to form the code of the coding pair; and
a compressor accepting the coding pair, with the number of mantissa bits depending on the code, to form a compressed model variable of the stream of compressed model variables every coding time interval.

15. The interface apparatus of claim 14, wherein the compressor uses ANS, and the coding time interval is one clock cycle.

16. An interface apparatus for decompressing a stream of compressed model variable into model variables in fixed-point format internal to a device, the apparatus comprising:
a decompressor to produce a coding pair every decoding time interval, the coding pair being for a fixed-point format and consisting of a code and additional data whose size depends on the code;
a converter to convert the additional data to a two's complement integer;
a lookup table to map the code to an exponent; and
a shifter to use the exponent to shift the two's complement integer into a fixed-point integer model variable in the device.

17. The interface apparatus of claim 16, wherein the decompressor uses ANS, and the decoding time interval is one clock cycle.
